(19) United States
(12) Patent Application Publication
(10) Pub. No.: US 2006/0275028 A1
(43) Pub. Date: Dec. 7, 2006

(54) System, apparatus and method for generating panorama image

(75) Inventors: Ki-moon Lee, Seongnam-si (KR); Jung-mo Hong, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/441,209

(22) Filed: May 26, 2006

(30) Foreign Application Priority Data
Jun. 3, 2005 (KR) 2005-47682

(51) Int. Cl. G03B 17/18

(52) U.S. Cl. 396/287

(57) ABSTRACT

A system, apparatus and method for generating a panorama image are provided. The panorama image generating system includes an image obtaining device that inputs a plurality of images, and a panorama image generating device that comprises a user interface for providing preview images for the plurality of images received from the image obtaining device, and a panorama generator for generating a panorama image by combining the plurality of images. As a result, a panorama image is obtained by using a driver without having to use an extra image editing tool.

### CROSS-REFERENCE TO RELATED APPLICATIONS

This application claims all benefits accruing under 35 U.S.C. §119 from Korean Patent Application No. 2005-47682, filed on Jun. 3, 2005, in the Korean Intellectual Property Office, the disclosure of which is incorporated by reference herein.

### BACKGROUND OF THE INVENTION

1. Field of the Invention

The present invention relates to a system, apparatus and method for generating a panorama image, and more particularly, relates to a system, apparatus and method for generating a panorama image using a driver program of an image obtaining device.

2. Related Art

Typical peripherals for computer systems are input devices such as a key board or mouse, and output devices such as printers, photocopiers, facsimile machines or multi-functional products. With the developments of peripherals for computer systems, image obtaining devices such as scanners or digital cameras are becoming increasingly useful in recent years.

In order to obtain an image, a user scans a document using a scanner, or directly photographs an image using a digital camera, then connects the scanner or digital camera to a computer system, and downloads an image from the scanner or digital camera to the computer system.

More specifically, a user executes an application of an image obtaining device, such as a scanner or a digital camera, using the computer system, and inputs a command to obtain an image to the executed application, via an input device. Upon receiving the command, the application transmits the command to a driver program of the image obtaining device and the image obtaining device is driven by the driver program. Accordingly, an image is obtained from the image obtaining device.

In obtaining an image using the image obtaining device as described above, a size of an image that is obtainable at once is limited. Therefore, in order to obtain an image of a larger size, a user must obtain several sheets of images and then combine those images, thereby creating a single image. The process of creating a single image using several images combined is known as a “panoramic image processing.”

According to the conventional process of creating a panorama image, a panorama image is generated using a special application designed to support a panorama function, or using an image editing device separately installed in a computer system.

However, a process of managing separate images in a specific order is required. In addition, since an extra image editing device or application is required, there is a problem of high cost associated with such a panorama function. Also, a user has to be trained and/or fully aware of the functions of the tool (i.e., an image editing device or a special application supporting a panorama function) to generate a panorama image.

### SUMMARY OF THE INVENTION

Several aspects and example embodiments of the present invention provide a system, apparatus and method for generating a panorama image, which combines a plurality of images using a continuous preview function provided by a driver of an image obtaining device, thereby generating a panorama image without requiring an extra program or an extra image editing device.

Additional aspects and/or advantages of the invention will be set forth in part in the description which follows and, in part, will be obvious from the description, or may be learned by practice of the invention.

In accordance with an embodiment of the present invention, a panorama image generating system is provided with an image obtaining device to obtain a plurality of images; and a panorama image generating device connected to the image obtaining device, to provide preview images for the plurality of images received from the image obtaining device, and comprising a user interface for providing the preview images, and a panorama generator for generating a single panorama image by combining the plurality of images.

According to an aspect of the present invention, a panorama image generating apparatus comprises an input unit to receive a plurality of images; a user interface arranged to provide preview images for the plurality of images received from the input unit; and a panorama generator arranged to generate a panorama image by combining the plurality of images.

In accordance with another embodiment of the present invention, a panorama image generating apparatus comprises an input unit to receive a plurality of images; and a driver unit arranged to preview images for the plurality of images received through the input unit, and generate a panorama image by combining the plurality of images.

According to an aspect of the present invention, the input unit receives the plurality of images from an external image obtaining device or a scan unit. The user interface provides preview images for the plurality of images. The user interface provides a menu to activate a panorama function according to a user selection, and provides a menu to set combination positions where the plurality of images is lined up with one another. The user interface provides the preview images for the plurality of images with the same resolution.

According to an aspect of the present invention, a storage unit is further provided to store the panorama image generated by the panorama image generator.

In accordance with yet another embodiment of the present invention, a method for generating a panorama image, comprises receiving a plurality of images, providing preview images for the plurality of images received, and generating a panorama image by combining the plurality of images according to a predetermined requirement.

According to an aspect of the present invention, the method further comprises receiving a request signal to activate a panorama function from a user. The preview images for the plurality of images are provided with the same resolution. In addition, prior to generating the panorama image, combination positions where the plurality of images are lined up with one another can further be set, and the generated panorama image can also be stored.

In addition to the example embodiments and aspects as described above, further aspects and embodiments will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 is a block diagram illustrating an example panorama image generating system according to an embodiment of the present invention;

FIGS. 2A to 2C are view to explain functions of a driver program executed at the panorama image generating device shown in FIG. 1; and

FIG. 3 is a flowchart illustrating a method for generating a panorama image according to an embodiment of the present invention.

### DETAILED DESCRIPTION OF EXAMPLE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

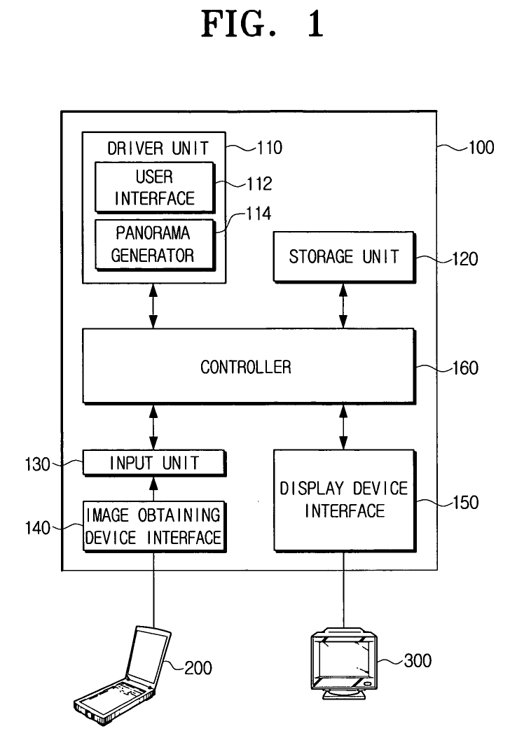

FIG. 1 is a block diagram illustrating an example panorama image generating system according to an embodiment of the present invention.

Referring to FIG. 1, a panorama image generating system comprises a panorama image generating device 100, an image obtaining device 200, and a display device 300.

The panorama image generating device 100, the image obtaining device 200 and the display device 300 are connected to one another according to one of standards for connecting devices to enable data transmission, including a wired connecting standard such as universal asynchronous receiver/transmitter (UART), universal serial bus (USB), and local area network (LAN), and a wireless connecting standard such as Wi-Fi, Bluetooth and ultra-wideband networks using compatible wireless application protocols for wireless transmission as specified by IEEE 802.11(a), (b) and/or (g) standards, Bluetooth standards and other emerging wireless personal area networks such as Wi-Max.

According to an embodiment of the present invention, the panorama image generating device 100 can be a computer system, a workstation or other computing device, arranged to connect to an image obtaining device 200 to obtain an image. In addition, the panorama image generating device 100 can also be a multi-functional printer (MFP) having its own scan function. In this case, it is possible for the panorama generating device 100 to obtain an image using a scan function, although it is not connected to the image obtaining device 200.

As shown in FIG. 1, the panorama image generating device 100 comprises a driver unit 110, a storage unit 120, an input unit 130, an image obtaining device interface 140, a display device interface 150, and a controller 160.

The driver 110 comprises a user interface (UI) 112 to allow a user to use various functions provided by an image obtaining device 200 to control the image obtaining device 200, and a panorama generator 114 to generate a panorama image.

When receiving a plurality of images, the driver unit 110 controls the user interface 112 to display preview images for the plurality of images in a single display, and controls the panorama generator 114 to combine the plurality of images into a single panorama image.

According to an embodiment of the present invention, such a driver unit 110 is a software module (driver program) acting as a translator between an image obtaining device 200 and programs such as an operating system (OS) installed at the panorama image generating device 100 that use the image obtaining device 200. In particular, the driver unit 110 accepts commands from the controller 160 and translates these commands into specialized commands for the image obtaining device 200. The driver software unit may be a software module provided on a tangible medium, such as a floppy disk or compact disk (CD) ROM, or via Internet downloads, which may be available for an administrator to conveniently plug-in or download into the host operating system (OS). Such software module may also be bundled with the existing operating system (OS) which may be activated by a user for automating integration into the host operating system (OS). Alternatively, the driver software may also be available as a firmware module or a comprehensive hardware/software module which may be built-in the host panorama image generating device 100. The operating system (OS) may include any industry standard system such as the Berkeley Software Development, Inc (BSDI) O.S. (Unix-based), Microsoft Disk Operating System (DOS), Apple Macintosh OS, Novell Netware, AT&T UNIX, DEC VMS, or Microsoft Windows.

Since the image obtaining device 200 is a scanner in an embodiment as shown in FIG. 1, the driver unit 110 is a driver program suitable to the scanner. However, if the image obtaining device 200 is a digital camera or camcorder, the driver unit 110 has to be a driver program suitable to the digital camera or camcorder.

Generally, the driver program suitable to the scanner transmits a scan command to the scanner and provides the UI 112 that includes a menu to set a type of image, a menu to set a resolution, a menu to set a size of image, and a menu to enlarge/reduce a ratio of image.

In addition to the above menus, the UI 112 provides a menu to activate a panorama function according to a user selection and a menu to set a combination position where the plurality of images is lined up with one another. Such an UI 112 is a graphical user interface provided to enable a user to activate the panorama function and make image selection.

Simultaneously, the UI 112 provides preview images for the plurality of images input through the image obtaining device interface 140. Accordingly, the user can preview the plurality of images with his/her naked eyes and determine the combination position.

In order to combine the images more accurately, the UI 112 provides preview images with the same resolution, i.e. the same dot per inch (DPI) for the plurality of images.

The panorama generator 114 combines the plurality of images input through the input unit 130 and thereby generates a single panorama image. The panorama generator 114 generates the panorama image based on the combination position between images that is set through the UI 112.

The storage unit 120 typically comprises a read only memory (ROM) and a random access memory (RAM). The ROM stores various control programs that are necessary to implement the functions of the panorama image generating device 100. That is, the ROM stores an operation system (OS) which is a control program of the controller 160. The RAM temporarily stores various data that are created subsequent to the executing of the program of the controller 160. The RAM, which is a main memory of the controller 160, loads a program to be executed by the controller 160 from the ROM and stores the program.

According to an embodiment of the present invention, the storage unit 120 also stores the panorama image generated by the panorama generator 114 under the control of the controller 160.

The input unit 130 transmits the plurality of images to the driver unit 110 under the control of the controller 160. If the panorama image generating device 100 is a computer system, the input unit 130 receives the plurality of images from the image obtaining device 200. Alternatively, if the panorama image generating device 100 is a multi-functional printer (MFP) having its own scan function, the input unit 130 receives the plurality of images from an internal scan unit.

The image obtaining device interface 140 provides interface between the panorama image generating device 100 and the image obtaining device 200. In this embodiment, the image obtaining device interface 140 receives the plurality of images from the image obtaining device 200 one by one in sequence, and provides the received images to the controller 160.

The display device interface 150 provides interface between the panorama image generating device 100 and the display device 300. The display device interface 150 transmits information to be displayed by the display device 300 under the control of the controller 160. Preferably, the UI 112 provided by the driver unit 110 is displayed by the display device 300.

The controller 160 executes the control program stored in the ROM of the storage unit 120, and controls overall operations of the panorama image generating device 100. The controller 160 controls signal input/output among the driver unit 110, the storage unit 120, the input unit 130, the image obtaining device interface 140 and the display device interface 150.

When the plurality of images are input through the image obtaining device interface 140 and the input unit 130, the controller 160 controls the driver unit 110 to provide preview images for the plurality of images.

When a panorama image is generated by the panorama generator 114 of the driver unit 110, the controller 160 controls the panorama image to be temporarily or permanently stored to the storage part 120.

The image obtaining device 200 obtains an image and provides the image to the panorama image generating device 100 according to a predetermined connecting standard. In this embodiment, the image obtaining device 200 is a scanner that scans document and thereby obtains a digital image. However, this should not be considered as limiting. The image obtaining device 200 may be a digital camera or camcorder that photographs a still image such as person or landscape and thereby obtains a digital image.

The display device 300 is connected to the panorama image generating device 100 to provide a visual display of information transmitted from the panorama image generating device 100. According to an embodiment of the present invention, the display device 300 displays the UI 112 provided by the driver unit 110, and provides the preview images for the plurality of images through the UI 112.

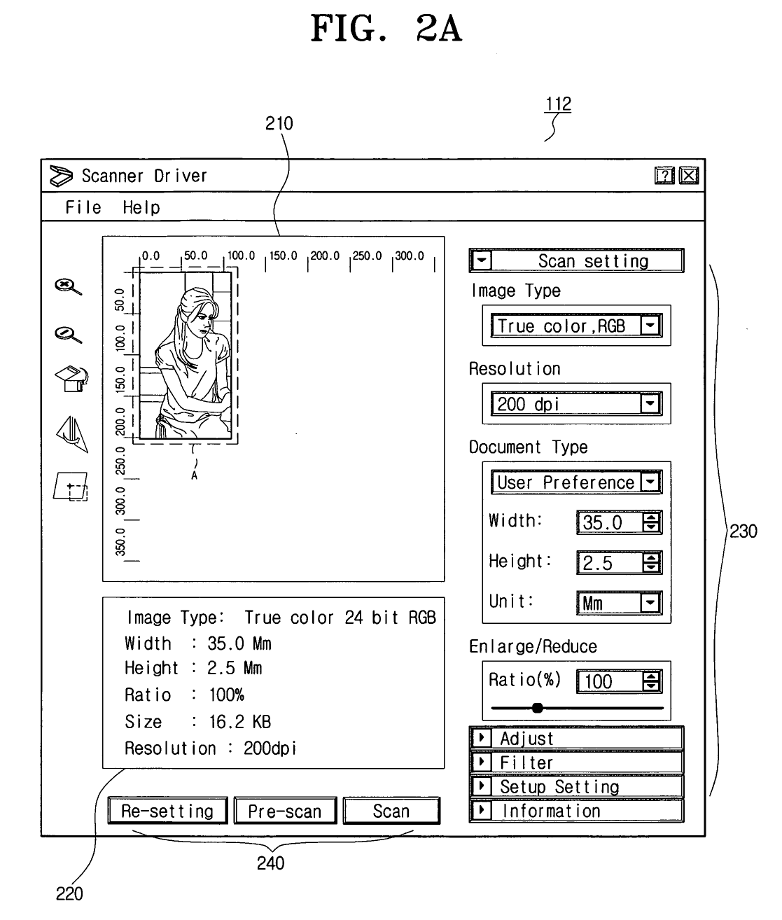

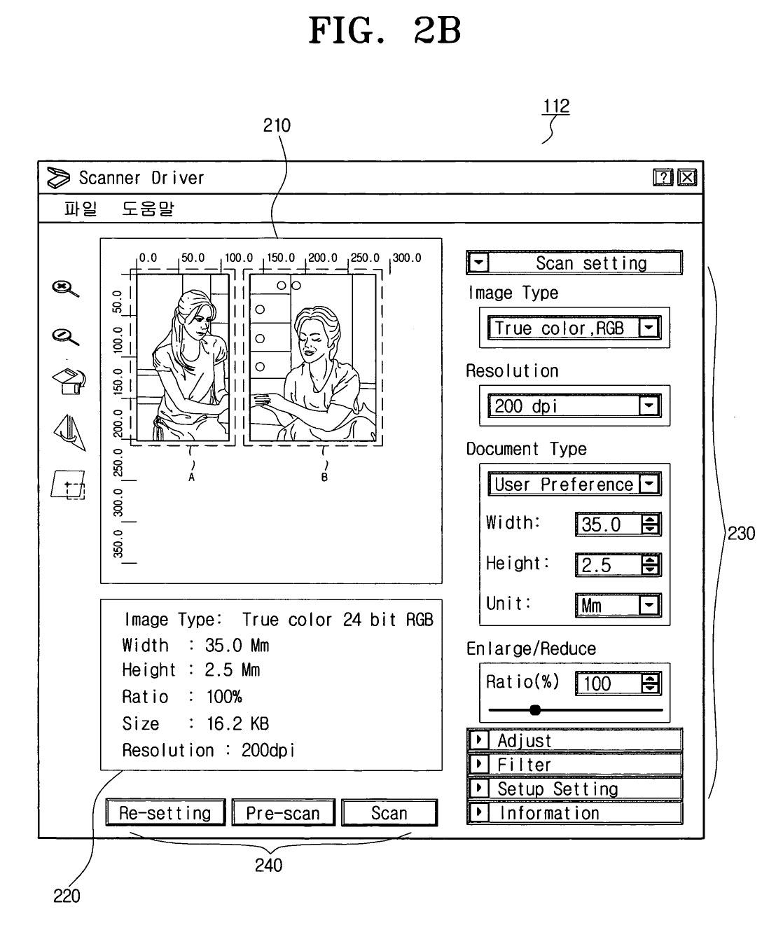

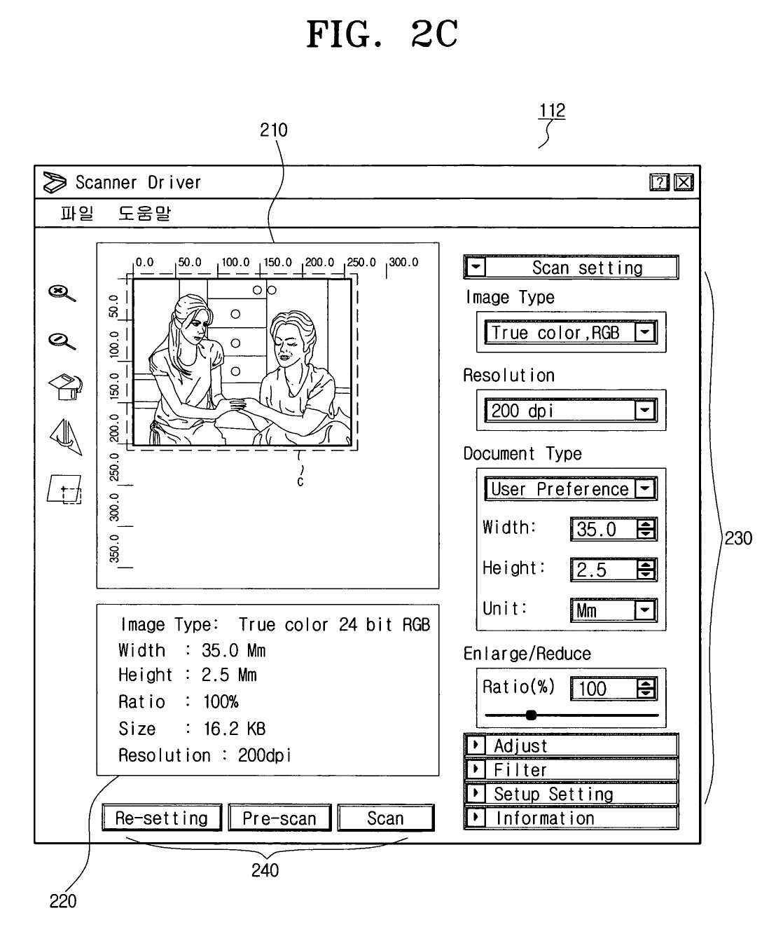

FIGS. 2A to 2C are views to explain functions of the driver unit of a panorama image generating device shown in FIG. 1.

With reference to FIGS. 2A to 2C, the UI 112 provided by the driver unit 110 for showing the functions of the driver unit 110 will now be explained as follows. A first image among the plurality of images received is referred to as a first image A, and a second image is referred to as a second image B for purposes of brevity. In this embodiment, two images are combined, but this should not be considered as limiting.

FIG. 2A shows a preview image of the first image A in an image window 210 provided on the UI 112, FIG. 2B shows preview images of the first image A and the second image B in an image window 210 provided on the UI 112, and FIG. 2C shows a preview image of a panorama image C that is obtained by combining the first and the second images A and B in an image window 210 provided on the UI 112. In addition to the image window 210, the UI 112 also provides an image characteristic window 220 including specific parameters of an image displayed on the image window 210, for example, an image type, a width and a height of an image, a ratio for enlargement/reduction, and a resolution, all of which are controlled by corresponding control windows 230, and function windows 240.

Referring to FIG. 2A, when the first image A is input through the image obtaining device interface 140 and the input unit 130, the preview image of the first image A is displayed by the display device 300 through the UI 112 of the driver unit 110.

Referring to FIG. 2B, when the second image B is input through the image obtaining device interface 140 and the input unit 130, with the preview image of the first image A being displayed, the preview images of the first and the second images A and B are separately displayed in a single display through the UI 112 of the driver unit 110. It is preferable to display the first and the second images A and B with the same resolution.

Through the UI 112, as shown in FIG. 2B, a user drags the first image A or the second image B by using a mouse, and positions these images in the image window 210 such that edges of the first and the second images A and B are lined up with each other.

The first and the second images A and B of FIG. 2B are combined into a single image as shown in FIG. 2C by the above-described operation and the preview image of a single image is displayed as shown in FIG. 2C. The panorama generator 114 combines the plurality of images into a single a panorama image.

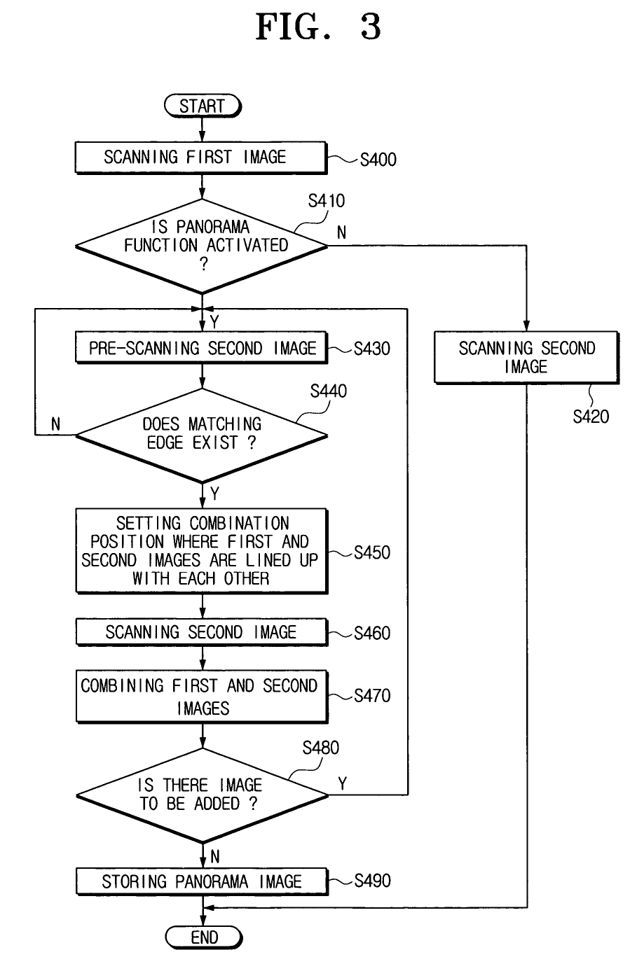

FIG. 3 is a flowchart illustrating a method for generating a panorama image according to an embodiment of the present invention. Referring to FIGS. 1 to 3, the method for generating a panorama image according to an embodiment of the present invention will now be described as follows.

The image obtaining device 200 scans a first image A and transmits the scanned first image A to the panorama image generating device 100. The panorama image generating device 100 stores the incoming first image A to the storage part 120, and the driver part 110 provides a preview image of the first image A through the UI 112 at operation S400.

After providing the preview image of the first image A through the UI 112, the driver unit 110 determines whether a menu to activate a panorama function is selected by a user at operation S410.

If the menu to activate a panorama function is not selected at operation S410, the driver unit 110 performs a general scanning operation, and thus scans a second image B at operation S420.

If the menu to activate a panorama function is selected at operation S410, the driver unit 110 pre-scans the second image B and displays preview images of the first and the second images A and B simultaneously in an image window 210 provided on the UI 112, as shown in FIG. 2B, at operation S430.

A user then determines whether a matching edge between the first and the second images A and B exist by referring to the preview images of the first and the second images A and B at operation S440. The matching edge may be detected by the driver unit 110.

If the matching edge does not exist at operation S440, the process goes back to the operation S430 such that the driver unit 110 again pre-scans the second image B.

If the matching edge exists at operation S440, a user sets a combination position where the first and the second images A and B are lined up with each other in the image window 210 provided on the UI 112 by selecting a menu to set a combination position through the UI 112 provided by the driver unit 110 at operation S450.

The driver part 110 transmits a scan command to the image obtaining device 200, and the image obtaining device 200 actually scans the pre-scanned second image B at operation S460.

When the scanned second image B is input through the image obtaining device interface 140 and the input unit 130, the driver unit 110 controls the panorama generator 114 to combine the first and the second images A and B. The panorama generator 114 combines the first and the second images A and B according to the composition position set through the UI 112. Accordingly, a single image composed of the two images is generated as shown in FIG. 2C at operation S470.

If there are additional images to be added, the process goes back to the operation S430 to pre-scan an image. However, if there is no image to be added, the panorama image generated by the panorama generator 114 is stored in the storage unit 120 at operations S480 and S490.

According to the method for generating a panorama image of the present invention as described above, it is possible to easily generate a panorama image simply by using the driver unit 110 without having to use an extra image editing tool.

Since the system, device and method for generating a panorama image according to the present invention are provided with a function of providing preview images for the plurality of images and a function of generating a panorama image, a user can easily set the combination position between images and thereby generate a panorama image simply and effectively. As a result, a user is not required to purchase and install an extra image editing tool and thus is not required to be aware of the complicated functions thereof. Also, the driver unit 110 according to an embodiment of the present invention is compatible with all conventional image obtaining device drivers and related software.

According to an embodiment of the present invention, the driver unit including a user interface 112 and a panorama generator 114, as shown in FIG. 1, can be one or more software modules written in C or C++ languages. However, such modules can also be written in a variety of software languages, including Java, Visual Basic, J2EE, SQL, Perl, Web Services, VB.NET and many other languages over the Internet. The various software modules may also be integrated in a single application executed on one or more control units (not shown), such as a microprocessor, a microcontroller, or a processor card (including one or more microprocessors or microcontrollers) in a computer system (PC). Alternatively, the software modules and individual components of each module can also be distributed in different applications or a single application executed by a single computing device connected to the packet-based network.

These software modules may include data and instructions which can also be stored on one or more machine-readable storage media, such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact discs (CDs) or digital video discs (DVDs).

Instructions of the software routines or modules for executing functions shown in FIG. 3 may also be loaded or transported into a panorama image generating device in one of many different ways. For example, code segments including instructions stored on floppy discs, CD or DVD media, a hard disk, or transported through an interface card, modem, or other interface device may be loaded into a panorama image generating device and executed as corresponding software routines or modules. In the loading or transport process, data signals that are embodied as carrier waves (transmitted over telephone lines, network lines, wireless links, cables, and the like) may communicate the code segments, including instructions, to the network node or element. Such carrier waves may be in the form of electrical, optical, acoustical, electromagnetic, or other types of signals.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. As a result, many modifications, permutations, additions and sub-combinations may be made to adapt the teachings of the present invention to a particular situation without departing from the scope thereof. For example, the invention is also applicable to all data networks and compatible protocols. Moreover, alternative embodiments of the invention can be implemented as a computer program product for use with a computer system. Such a computer program product can be, for example, a series of computer instructions stored on a tangible data recording medium, such as a diskette, CD-ROM, ROM, or fixed disk, or embodied in a computer data signal, the signal being transmitted over a tangible medium or a wireless medium, for example microwave or infrared. The series of computer instructions can constitute all or part of the functionality described above, and can also be stored in any memory device, volatile or non-volatile, such as semiconductor, magnetic, optical or other memory device. Accordingly, it is intended, therefore, that the present invention not be limited to the various example embodiments disclosed, but that the present invention includes all embodiments falling within the scope of the appended claims.

What is claimed is:

1. A panorama image generating system comprising:
an image obtaining device to obtain a plurality of images; and
a panorama image generating device connected to the image obtaining device, to provide a preview of one or more images received from the image obtaining device, the panorama image generating device comprising a user interface for providing preview images, and a panorama generator for generating a single panorama image by combining the plurality of images.

2. The panorama image generating system as claimed in claim 1, wherein the user interface provides the preview images for the plurality of images.

3. A panorama image generating apparatus comprising:
an input unit to receive a plurality of images;
a user interface arranged to provide preview images for the plurality of images received from the input unit; and
a panorama generator arranged to generate a panorama image by combining the plurality of images.

4. The panorama image generating apparatus as claimed in claim 3, wherein the input unit receives the plurality of images from an external image obtaining device.

5. The panorama image generating apparatus as claimed in claim 3, wherein the user interface provides the preview images for the plurality of images.

6. The panorama image generating apparatus as claimed in claim 3, wherein the user interface provides a menu to activate a panorama function according to a user selection.

7. The panorama image generating apparatus as claimed in claim 3, wherein the user interface provides a menu to set combination positions where the plurality of images are lined up with one another.

8. The panorama image generating apparatus as claimed in claim 3, wherein the user interface provides the preview images for the plurality of images with the same resolution.

9. The panorama image generating apparatus as claimed in claim 3, further comprising a storage unit to store the panorama image generated by the panorama generator.

10. A panorama image generating apparatus comprising:
an input unit to receive a plurality of images; and
a driver program installed to provide preview images for the plurality of images received through the input unit, and generate a panorama image by combining the plurality of images.

11. The panorama image generating apparatus as claimed in claim 10, wherein the input unit receives the plurality of images from a scan unit.

12. A method for generating a panorama image, comprising:
receiving a plurality of images;
providing preview images for the plurality of images received; and
generating a panorama image by combining the plurality of images according to a predetermined requirement.

13. The method as claimed in claim 12, further comprising receiving a request signal to activate a panorama function from a user.

14. The method as claimed in claim 12, wherein the preview images for the plurality of images are displayed with the same resolution.

15. The method as claimed in claim 12, further comprising, prior to generating the panorama image, setting combination positions where the plurality of images are lined up with one another.

16. The method as claimed in claim 12, further comprising storing the generated panorama image.

17. The panorama image generating apparatus as claimed in claim 10, wherein the driver program comprises:
a graphical user interface to scan an image and to provide a preview of one or more images received from an image obtaining device, via the input unit, and to provide a menu to activate a panorama function according to a user selection and to set combination positions where two or more images are lined up to form a single panorama image; and
a panorama generator arranged to generate the single panorama image based on a combination of two or more images lined up, via the graphical user interface.

18. The panorama image generating apparatus as claimed in claim 17, further comprising a storage unit arranged to store the panorama image generated from the panorama generator.

19. The panorama image generating apparatus as claimed in claim 18, wherein the driver program is integrated into a host operating system (OS) to enable a user to preview one or more images received from the image obtaining device, via the input unit, and to perform the panorama function.

20. The panorama image generating system claimed in claim 1, wherein the image obtaining device corresponds to one of a scanner, a digital camera and a camcorder, and wherein the panorama image generating device corresponds to a personal computer (PC).
